(19) United States
(12) Patent Application Publication
(10) Pub. No.: US 2003/0153226 A1
(43) Pub. Date: Aug. 14, 2003

(54) Method for protecting surfaces of packed articles

(76) Inventors: David C. Jones, Midlothian, VA (US); Hyun Sung Lim, Midlothian, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/378,966

(22) Filed: Mar. 4, 2003

Related U.S. Application Data
(62) Division of application No. 09/929,929, filed on Aug. 15, 2001.

(51) Int. Cl. B32B 5/18; B32B 5/22; B32B 5/02; B32B 27/04; B32B 27/12; B32B 5/24; B32B 9/04

(52) U.S. Cl. 442/76; 442/79; 442/86; 442/85; 428/411.1; 442/370; 442/374

(57) ABSTRACT

The present invention is directed to a method for packing an article comprising providing a vapor permeable and substantially water impermeable composite laminated sheet comprising a nonwoven layer and a polymer film layer, said composite laminated sheet having a trapezoidal tear strength of at least about 2 N in the machine direction, and a smoothness measured on the polymer film layer of less than 9 micrometers and placing the composite laminated sheet on the surface of the article with the polymer film layer contacting at least a portion of said surface.

### FIELD OF THE INVENTION

This invention relates to a method for protecting packed articles against surface damage, especially articles having painted surfaces such as painted automobile components. More particularly, the invention is directed to a method for protecting the surfaces of packaged articles, which includes placing a vapor permeable and substantially water impermeable composite laminated sheet on at least a portion of the surface of the article. The composite laminated sheet comprises a laminate of a vapor permeable, substantially water impermeable film layer and a nonwoven layer.

### BACKGROUND OF THE INVENTION

Packaging materials to protect packed articles against surface damage include plastic bubble wrap, paper, cardboard, adhesive films, styrofoam, and sheeting material made of nylon, polyester, and cotton.

When an article to be packed is made of or coated with a synthetic material that releases low volatility solvents or other gases, and which continues to release such low volatility solvents or gases after packaging, it is important that the packaging material not trap the released low volatility solvents or gases between the packed article and packaging material. Such trapped gases or side reactions between low volatility solvents and moisture can generate undesirable discoloration or blemishes in the finish on the packed article's surface. An example where this can be a problem is in the packaging of automobile bumper fascia. Two component paints that combine, for example, isocyanates with hydroxyl functional material, react to create urethanes. These two component systems are commonly referred to as “2K” and cure more slowly than previously used one component “1K” paint systems. These “2K” paints can continue to post cure for up to fourteen days after exiting from the drying oven at the manufacturing facility. Because there is often a shortage of storage space, the painted bumpers may be shipped to the automobile assembly plants while they are still post curing.

Published European Patent Application EP 959119 to Inoue et al. discloses sheets for protecting the painted surfaces of automobiles. The sheets comprise a nonwoven layer having a polymer film laminated to at least one surface thereof and a pressure-sensitive adhesive layer formed on the polymer film layer. The sheets are adhered without wrinkling to the painted automobile surfaces by the pressure-sensitive adhesive layer to prevent permeation of rainwater, which can cause surface damage. The films used in the laminates of Inoue et al. are not breathable and thus do not allow for release of low volatility solvents or gases that may be generated by off-gassing from the painted surfaces.

U.S. Pat. No. 5,763,336 to Jones et al. discloses a nonwoven bulky composite sheet material suitable for use in protective covers for articles such automobile bumpers. The composite sheet comprises first and second layers of a water impermeable, water vapor permeable synthetic sheet with a third layer of a bulky flexible material bonded between the first and second layers, for example by ultrasonic bonding. The first and second layers are preferably fibrous bonded nonwoven sheets such as Tyvek® flash-spun plexifilamentary polyethylene film-fibril sheet sold by E. I. du Pont de Nemours and Company of Wilmington, Del. Tyvek® flash-spun sheets are vapor permeable, are not abrasive, and are inert to most painted surfaces. Other sheets which can be used as the outer layers of the bulky composite include spunbond/meltblown/meltblown/spunbond (“SMMS”) polypropylene sheet material and microporous films such as Exxaire™ film sold by Tredegar Company of Richmond, Va. Covers made from the bulky laminates provide protection against surface damage, have good tear resistance, are re-useable, and do not trap solvent gases which are given off as a result of off-gassing from finishes such as curing paint.

However, it has been found in some instances when the bulky composites have been used in covers to protect freshly painted automobile parts, that markings on the painted surface are formed which correspond to the grid pattern created by the ultrasonic or thermal bonding points in the bulky composite. This is possibly due to different rates of diffusion of volatiles through the cover at the bonded and unbonded portions of the bulky composite. In some instances, an impression of the thermal point bond pattern on the Tyvek® surface (rib or linen) has been left on the paint. In addition, when dirt is trapped between the cover and the article being protected, scratches can be formed on the surface of the article by the dirt due to lateral movement of the protective cover with respect to the surface of the article. This is especially a problem when the article to be protected has a relatively soft finish layer on the surface, such as painted automobile bumpers where the paint has not cured completely prior to packaging. In some cases, additional spot protection of automobile bumpers has been used on the most commonly damaged areas of the bumper. For example, Rapgard® tape (available from Kansai Company, Japan) or Transeal® protective films have been used for spot protection by applying the tape or film to selected sections of the bumper prior to covering the bumper with a secondary protective cover such as the bulky composite cover disclosed in U.S. Pat. No. 5,763,336. However these methods also have some drawbacks. For example, Rapgard® tape is not breathable and therefore does not allow off-gassing of volatiles on the areas where it is applied. Although the Transeal® film is breathable, it requires pre-heating using expensive equipment in order to apply the film to the bumpers. Microporous films such as Aptra® film, available from Amoco, have been used as slip sheets under the bulky composite covers to eliminate the need for spot protection. However, microporous films are generally difficult to handle and easily torn, resulting in higher than desired yield losses and increased cost.

There is a need for a simplified, cost-effective method for protecting articles from surface damage caused by impact with other articles or by dirt which may find its way between protective covers and the article, as well as damage which can be caused by trapped volatile materials that are created during off-gassing of finished articles.

### SUMMARY OF THE INVENTION

A first embodiment of the present invention is directed to a method for packing an article comprising providing a vapor permeable and substantially water impermeable composite laminated sheet comprising a nonwoven layer and a polymer film layer, said composite laminated sheet having a trapezoidal tear strength of at least about 2 N in the machine direction, and a smoothness measured on the polymer film layer of less than 9 micrometers and placing the composite laminated sheet on the surface of the article with the polymer film layer contacting at least a portion of said surface.

A second embodiment of the present invention is a protective cover for packing an article comprising a vapor permeable and substantially water impermeable composite laminated sheet comprising a nonwoven layer and a polymer film layer, said composite laminated sheet having a trapezoidal tear strength of at least about 2 N in the machine direction, and a smoothness measured on the polymer film layer of less than 9 micrometers.

Another embodiment of the present invention is a vapor permeable, water impermeable composite laminated sheet comprising a first layer of polymer film bonded to a second layer of powder-bonded nonwoven web, wherein said polymer film is a monolithic extrudate.

Another embodiment of the present invention is a vapor permeable, water impermeable composite laminated sheet consisting of a first layer of microporous polymer film bonded to a second layer of powder-bonded nonwoven web and optionally a cushioning layer.

### BRIEF DESCRIPTION OF THE DRAWING

FIG. 1 is a schematic representation of a process by which the composite laminated sheet structure of the invention can be made.

### DESCRIPTION OF THE PREFERRED EMBODIMENTS

The current invention provides a method for protecting packed articles against surface damage which includes the step of placing a vapor permeable and substantially water impermeable composite laminated sheet on at least a portion of the surface of the part. The composite laminated sheet comprises a polymeric film layer and a nonwoven layer. The composite laminated sheet is placed on the surface of the article to be packed such that the film side of the composite laminated sheet contacts at least a portion of the surface of the article. Preferably, the composite laminated sheet is sufficiently strong and durable to be re-used several times.

The term “vapor permeable” as used herein is intended to encompass permeation of both water vapor, solvent vapors and other such gases.

The term “nonwoven fabric, sheet, or web” as used herein means a structure of individual fibers or filaments that are positioned in a random manner to form a planar material without an identifiable pattern by means other than knitting or weaving. As used herein, the term “fiber” means an elongated strand of defined length, such as staple fibers formed by cutting a continuous strand into lengths and the term “filament” means a generally continuous strand that has a very large ratio of length to diameter.

As used herein, the “machine direction” is the long direction within the plane of a sheet, i.e., the direction in which the sheet is produced. The “cross direction” is the direction within the plane of the sheet that is perpendicular to the machine direction.

The term “powder-bonded nonwoven” as used herein refers to a bonded nonwoven fabric formed by depositing a powder adhesive, which melts at a temperature below the melting point of the fibers of the carded web, onto an unbonded carded fibrous web so that the powder adhesive is distributed throughout the thickness of the carded web. Thereafter, the powder-containing web is heated to melt the powder adhesive without melting the fibers of the carded web to form a powder-bonded nonwoven. Powder-bonded nonwovens are distinguished from sheets made using powder lamination methods such as that described in Shehata U.S. Pat. No. 5,445,874 where an activated web consisting of an adhesive material is formed from an adhesive powder. In powder lamination, the powder adhesive bonds two substrates together, such as a woven or nonwoven substrate with a film layer and the adhesive powder is concentrated primarily at the interface between the two substrates. In powder lamination, the powder adhesive does not contribute to any significant degree to the bonding within the nonwoven substrate.

The term “spunbond” as used herein means a nonwoven formed by melt extrusion of a polymer into strands that are quenched and drawn, usually by high velocity air, to strengthen the filaments. The filaments are collected on a forming surface and bonded, often by application of heat and pressure using a patterned bonding roll.

The term “plexifilamentary” as used herein, means a three-dimensional integral network of a multitude of thin, ribbon-like film-fibril elements of random length and with a mean film thickness of less than about 4 microns and a median fibril width of less than about 25 microns. In plexifilamentary structures, the film-fibril elements are generally co-extensively aligned with the longitudinal axis of the structure and they intermittently unite and separate at irregular intervals in various places throughout the length, width, and thickness of the structure to form a three-dimensional network. Plexifilamentary film-fibril fibers are obtained by a flash-spinning process. In the process for making flash-spun fibers, as disclosed in U.S. Pat. No. 3,081,519 to Blades et al. (assigned to DuPont), a solution of fiber-forming polymer in a liquid spin agent that is not a solvent for the polymer below the liquid's normal boiling point, is maintained at a temperature above the normal boiling point of the liquid and at autogenous pressure or greater, and is then spun into a zone of lower temperature and substantially lower pressure to generate plexifilamentary film-fibril strands.

The polymeric film and nonwoven layers of the composite laminated sheet are selected and combined in such a way to form a composite laminated sheet that is both vapor permeable and substantially water impermeable. The composite laminated sheet preferably has a hydrostatic head of at least 100 cm, preferably greater than 400 cm and a moisture vapor transmission rate of at least 100 g/m²/24 hr, preferably at least 800 g/m²/24 hr and a trapezoidal tear strength of at least about 2 N in the machine direction. The composite laminated sheet should be flexible and drapeable so that it conforms to the surface of the article to be protected during packaging. The film layer and nonwoven layer are combined to form the composite laminated sheet in such a way that the outer surface of the film layer is substantially smooth and does not leave a visible imprint on or other markings on the surface of the article to be protected. This is especially important where the article to be packaged has a soft, high-gloss finished surface such as freshly painted surface that may not have fully hardened or cured prior to packaging. The film layer of the composite laminated sheet also preferably has a smoothness of less than about 9 micrometers, preferably less than 7 micrometers when measured using a Parker Print Surf Test.

It is also important that once the composite laminated sheet has been contacted with the article during packaging that the composite laminated sheet does not move laterally or shift its position relative to the surface of the article to be packaged. Therefore, in addition to being smooth, a film layer is chosen that is somewhat tacky, i.e. which has good anti-slip properties. This further prevents surface damage of the article being packaged, especially when dirt inadvertently becomes trapped between the film layer of the composite laminated sheet and the surface of the article that is packaged. The trapped dirt could cause scratching of the article's surface finish if the composite laminated sheet shifts laterally relative to the finished surface. Using a film layer with an anti-slip surface also avoids the need for use of an adhesive layer on the polymeric film which would, in addition to increasing the cost of the composite laminated sheet, cause potential problems with adhesive residue being left on the article to be packaged after removal of the composite laminated sheet. Point-bonded flash-spun Tyvek® sheets used in protective covers described in Jones et al. U.S. Pat. No. 5,763,336 have a slip angle of 3.9 to 15.1 degrees when measured according to TAPPI Method T-503. The composite laminated sheet used in the method of the current invention preferably has a slip angle of at least about 15 degrees, and more preferably at least about 31 degrees when measured on the polymer film side. The higher the slip angle, the greater the anti-slip properties of the sheet. The bond strength between the polymer film and nonwoven layer of the composite laminated sheet is preferably at least 0.1 lb/in (0.18 N/cm), and more preferably greater than about 0.15 lb/in (0.26 N/cm).

Suitable nonwoven layers include powder-bonded, saturation-bonded, needlepunched, spunbond, and flash-spun nonwoven fabrics. The surface of a nonwoven layer that is adjacent the polymer film layer should be relatively smooth so as to avoid transfer of any pattern caused by the surface topography of the nonwoven layer through the film layer and onto the surface of the packaged article. The nonwoven layer preferably has a basis weight in the range of 0.4 oz/yd² to 2 oz/yd² (13.6 g/m² to 68 g/m²), more preferably in the range of 0.5 oz/yd² to 1.0 oz/yd² (17 g/m² to 34 g/m²). If the basis weight of the nonwoven layer is too low, it will not impart sufficient strength to the composite laminate which may cause the composite laminate to tear during handling. The composite laminated sheet preferably has a tensile strength of at least 3.3 N/cm and a trapezoidal tear strength of at least about 2 N in the machine direction, and more preferably at least about 3.9 N in either or both of the machine and cross directions. If the basis weight of the nonwoven layer is too high, the composite laminated sheet will not be sufficiently flexible or drapeable to conform to the surface of the article to be protected during packaging.

In a preferred embodiment, the nonwoven layer is a powder-bonded nonwoven web. Powder-bonded nonwoven webs useful in the current invention are prepared using methods known in the art, such as the process described in Zimmerman et al. U.S. Pat. No. 4,845,583. A carded web is prepared from staple fibers, the fibers preferably having a length between 1 and 2 inches (2.54 to 5.08 cm) and denier between 1 denier per filament (1.1 dtex) and 2 denier per filament (2.2 dtex). The carded web is optionally passed through a web spreading section prior to applying a powdered adhesive material. The adhesive powder is applied to the carded web using a powder-depositing device. The powder drops onto the web and is distributed through the web by gravity. Excess powder falls through the web and is collected for recycling. The weight of powder deposited in the web is preferably between about 8 to about 30 weight percent, more preferably between about 10 to about 20 weight percent based on the total weight of the carded web and powder adhesive. The bonding powder should have a lower melting point than the fibers in the carded web. In general, the bonding powder will be a thermoplastic material that is compatible with the fibers of the carded web so as to form a good adhesive bond with the fibers of the carded web. When polyester fibers are used to form the nonwoven layer, it is particularly preferred to use a polyester or copolyester bonding powder such as those available from EMS-American Grilon, Inc. Typical copolyester powder adhesives have melting points of from 100 to 130° C. and are available as coarse powders (200-420 microns or 70-40 U.S. standard mesh), medium powders (80-200 microns or 200-70 U.S. standard mesh) and fine powders (80 microns or less, or finer than 200 U.S. standard mesh), the medium powders being preferred when mechanical applicators are used to apply the adhesive powder to the web. Bonding of the powder-containing web can be achieved by passing the powder-containing web through an oven, such as an infrared oven causing the adhesive powder to fuse and bond the fibers of the web at fiber crossover points where the fibers and the adhesive come into contact. Upon leaving the oven, the web is generally subjected to light pressure by means of a nip roll. Preferably the nip roll has a smooth surface, resulting in a powder-bonded nonwoven fabric having a smooth surface for bonding to the film layer in the composite laminate.

The polymer film layer of the composite laminated sheet is vapor permeable and substantially liquid (especially water) impermeable and is selected from materials that are inert to the painted or otherwise finished surfaces of packaged article. Polyethylene, polypropylene, polyesters, and polyurethanes have all been found to be compatible with current automotive paint systems. A pre-formed film can be laminated to the nonwoven layer using thermal and adhesive laminating methods known in the art; or the polymer film layer can be a monolithic film or a microporous film precursor, extruded directly onto one of the surfaces of the nonwoven layer and adhered thereto without the application of an adhesive. This avoids problems associated with handling of thin films. Preferably, the film layer is less than 25 microns thick, more preferably less than 15 microns thick, and most preferably less than 12 microns thick and is essentially free of pinholes. The film layer is preferably comprised of a block polyether copolymer such as a block polyether ester copolymer, a poly(etheramide) copolymer, a polyurethane copolymer, and a poly(etherimide) ester copolymer, polyvinyl alcohols, or a combination thereof. Preferred copolyether ester block copolymers are segmented elastomers having soft polyether segments and hard polyester segments, such as those disclosed in Hagman, U.S. Pat. No. 4,739,012. Suitable copolyether ester block copolymers are sold by DuPont under the name of Hytrel®. Hytrel® is a registered trademark of DuPont. Suitable copolyether amide polymers are copolyamides available under the name Pebax® from Atochem Inc. of Glen Rock, N.J., USA. Pebax® is a registered trademark of Elf Atochem, S. A. of Paris, France. Suitable polyurethanes are thermoplastic urethanes available under the name Estane® from The B. F. Goodrich Company of Cleveland, Ohio, USA. Suitable copoly(etherimide) esters are described in Hoeschele et al., U.S. Pat. No. 4,868,062. Films of the above polymers are non-porous and are impermeable to water but permeable to vapors. For example, vapors are absorbed by and transported through the polymeric film layer from the side having higher vapor pressure, diffusing it across membrane to the side having the lower vapor pressure, where they are eliminated. In a preferred embodiment, the composite laminated sheet comprises a powder-bonded polyester nonwoven layer and a copolyether ester or polyurethane film layer. Alternately, a laminate of a powder-bonded polyamide nonwoven and a poly(etheramide) film can be used.

A composite laminated sheet with excellent tensile and peel strength, that does not emit loose fibers, can be produced using a carded web of staple fiber that is powder-bonded with an adhesive that is compatible with the fibers of the web. The composite laminated sheet is produced by extrusion coating the powder-bonded web with a molten thin film that is also compatible with the fibers of the web and the powder adhesive. “Compatibility” of thermoplastic materials is an art-recognized term that refers, generally, to the degree to which the thermoplastic materials are miscible with each other and/or interact with each other. “Incompatible” materials, as used herein, means materials that are substantially immiscible with each other or do not interact with each other. Incompatible materials do not wet or adhere well to each other, even when heated. As used herein, “compatible” materials are materials that are not “incompatible” with each other, as defined above. For purposes of this application, a fiber is deemed to be compatible with a synthetic adhesive or with another polymer if the adhesive or other polymer is miscible with material that comprises the majority of the fiber and if the adhesive or other polymer readily wets the fiber or if the adhesive or polymer can adhere well to the fiber. In a preferred embodiment, the composite laminated sheet of the present invention is composed of powder-bonded nonwoven web materials in which at least 95 weight percent of fibers in said nonwoven web are compatible with said polymer film.

When the polymer of the film layer is incompatible with the polymer of the nonwoven layer, the adhesion between the layers can be improved by addition of a compatibilizer to the film layer or by use of an adhesive layer or a co-extruded tie layer between the film layer and the nonwoven layer. Suitable compatibilizers are described in Carroll et al. published PCT Application WO 97/45259. For example, the polyether-based block copolymer films described above are not chemically compatible with nonwoven polyolefin webs. When the nonwoven layer comprises a polyolefin such as polypropylene or polyethylene, the film layer can comprise at least about 50 percent by weight of a Fraction A consisting essentially of a polymer from the group of block copolyether esters, block copolyether amides, polyurethanes, and combinations thereof, at least 5 weight percent of a Fraction B consisting essentially of a polymer from the group of homopolymers of an alpha-olefin, copolymers or terpolymers containing an alpha-olefin and one or more other monomers, and a block copolymer of a vinylarene and a conjugated diene, and at least 0.1 weight percent of a Fraction C consisting essentially of a compatibilizer for Fractions A and B. Examples of compounds suitable as Fraction B include copolymers of ethylene and propylene, ethylene vinyl acetate copolymers, copolymers of ethylene and acrylic derivatives (e.g. copolymers of ethylene, carbon monoxide and n-butyl acrylate), copolymers of ethylenically unsaturated carboxylic acid monomers (e.g. acrylic acid, methacrylic acid, crotonic acid, etc.) or the neutralized metallic salts thereof. The film Fraction C preferably consists essentially of homopolymers, copolymers and terpolymers with backbones that are compatible with Fraction B, the backbones being grafted with a monomer having a functional group that is compatible with Fraction A. Film Fraction C is preferably a polymer with a backbone identical to Fraction B, which backbone is grafted with monomer selected from the group of alpha- and beta-ethylenically unsaturated carbonic acids and anhydrides, and derivatives thereof. Preferred backbones for Fraction C include low density polyethylene, linear low density polyethylene, high density polyethylene, very low density polyethylene and polypropylene. The reactive group of Fraction C may be a grafting monomer that is grafted to this backbone and is or contains at least one alpha- or beta-ethylenically unsaturated carbonic acid or anhydride, or a derivative thereof. Examples of such carboxylic acids and anhydrides, which may be mono-, di-, or polycarboxylic acids, are acrylic acids, methacrylic acid, maleic acid, fumaric acid, itaconic hydride, maleic anhydride, and substituted maleic anhydride (e.g. dimethyl maleic anhydride). Examples of derivatives of the unsaturated acids are salts, amides, imides and esters (e.g. mono- and disodium maleate, acrylamide, maleimide and diethyl fumarate). Maleic anhydride is a preferred grafting monomer for the reactive group of Fraction C.

Other polymer film layers which are useful in preparing the composite laminated sheet for use in the current invention include polyethylene or polypropylene microporous films such as Exxaire™ microporous film available from Tredegar and Aptra® microporous film available from Amoco. Microporous films can be formed by mixing a matrix polymer with a substantial quantity of an organic or inorganic particulate filler and extruding a film from the blend. The film is heated and stretched which causes voids to form in the area surrounding the filler particles.

The microporous films can be combined with nonwoven layers in the manner disclosed in U.S. Pat. No. 5,865,926, to provide a composite laminated sheet for use in the current invention. A microporous film/spunbond composite laminated sheet called Vaporweb™, which is made by a one-step process which involves production of a spunbonded web, extrusion/lamination of CaCO₃-filled polymer film onto the spunbonded web and biaxial stretching of the film/spunbond composite, can be used for the current invention. A detailed description of the Vaporweb™ is published by Reifenhauser GmbH &Co, Germany at 9th Annual Nonwovens TANDEC conference held Nov. 10-12, 1999.

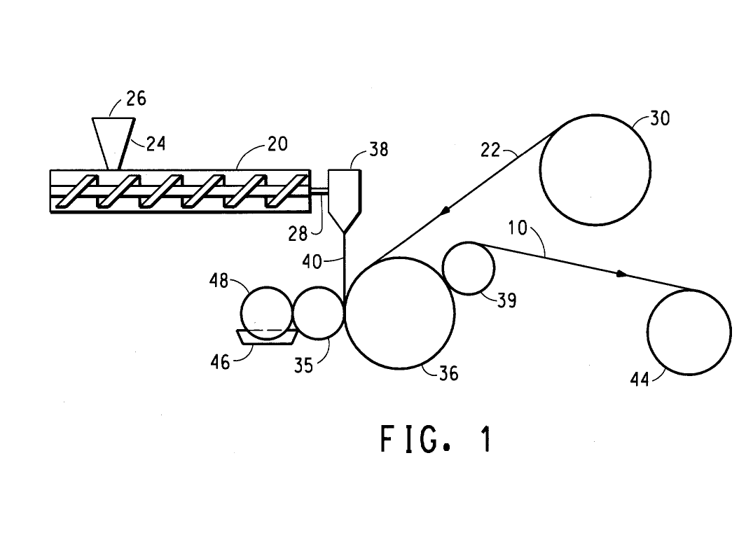

One preferred means for applying the film layer to the nonwoven layer is the extrusion process illustrated in FIG. 1. Melt processable polymer is fed in pellet form, along with any additives, into an inlet 26 of an extruder hopper 24, preferably under a nitrogen purge. The polymer is melted and mixed in a screw extruder 20 at a screw speed in the range of 100 to 200 rpm, depending on the dimensions of the extruder and the properties of the polymer. The melted mixture is discharged from the extruder under pressure through a heated line 28 to a flat film die 38. The polymer is discharged from the flat film die 38 at a temperature above the melting temperature of the polymer, and preferably at a temperature in the range of 180° C. to 240° C. The polymer melt 40 discharging from the flat film die 38 coats the fibrous nonwoven web 22 provided from supply roll 30.

Preferably, the fibrous web 22 passes under the die at a speed that is coordinated with the speed of the extruder so as to obtain a very thin film that preferably has a thickness of less than 25 microns. The coated web enters a nip formed between nip roll 35 and roll 36, which rolls are maintained at a temperature selected to obtain a composite laminated sheet with a desired bond strength and moisture vapor permeability. The temperature of rolls 35 and 36 is preferably within the range of 10° C. to 120° C. Higher roll temperatures yield a composite laminated sheet having a higher bond strength, while lower roll temperatures yield composite laminated sheets with a higher moisture vapor permeability. Preferably, nip roll 35 is a smooth rubber roll with a low-stick surface coating while roll 36 is a metal roll. Nip roll 35 can also have a matte or finely textured finish to prevent sticking of the film layer. Passing the coated web through the nip formed between cooled rolls 35 and 36 quenches the polymer melt while at the same time pressing the polymer melt 40 into contact with the fibers and adhesive of the fibrous web 22. The nip pressure applied should be sufficient to get the desired bonding between the film and the nonwoven but not so great as to create pinholes in the film layer. A water dip pan 46 with associated roll 48 can be used to increase the quench rate and to prevent sticking. The coated composite 10 is transferred from the roll 36 to another smaller roll 39 before being wound up on a collection roll 44.

The protective composite laminated sheets according to the present invention can further comprise additional layers laminated or bonded therein. For example, a layer of vapor permeable, open-celled polymer foam, such as polyurethane foam, can be flame laminated to the nonwoven layer surface of the composite laminated sheet described above to provide cushioning protection against mechanical damage to the underlying packed articles. Additionally, the outer surface of the open-celled polymer foam can be flame laminated to another nonwoven layer, such as a nonwoven web, to form a polymer film/nonwoven web composite laminated to a polymer foam/nonwoven web cushioning layer, without significant diminution of the vapor permeability of the composite laminated sheet. Alternatively, the open-celled polymer foam can be interposed between the polymer film layer and the nonwoven layer of the composite laminate.

In another embodiment, a microporous film is bonded to one side of a nonwoven web and the other side of said nonwoven web has an open-celled polymer foam, such as polyurethane foam, flame laminated thereto. Likewise, another layer of a nonwoven web can be flame laminated to the opposite side of the polymer foam to form a microporous film/nonwoven web composite laminated to a polymer foam/nonwoven web cushioning layer, according to the present invention. When the composite of the current invention has incorporated therein a cushioning layer as disclosed above, it is unnecessary to provide additional cushioning protection for the articles to be packaged.

In the method of the current invention, the composite laminated sheet is cut to the desired size and draped over the surface of the article to be packaged. When additional protection from impact with other articles is needed, a secondary protective cover can be applied around the article that has been draped with or otherwise covered by the composite laminated sheet. Preferably, the secondary cover is made of a cushioning material. In the case of painted automobile bumpers, a section of composite laminated sheet of the present invention is first draped over the bumper, then a padded protective cover can be placed around the covered bumper. For example, a secondary protective cover can be fabricated from a bulky composite sheet as described in Jones et al. U.S. Pat. No. 5,763,336. Protective covers for automobile bumpers can be fabricated from the bulky composite sheet by cutting an elongated oval section of the bulky sheet and stitching around its perimeter with an elastic band to form a cover resembling a shower cap. The elastic band holds the cover in place on the bumper.

### EXAMPLES

In the description above and in the non-limiting examples that follow, the following test methods were employed to determine various reported characteristics and properties. ASTM refers to the American Society for Testing and Materials, TAPPI refers to the Technical Association of Pulp and Paper Industry, and ISO refers to the International Organization for Standardization.

Basis weight was determined by ASTM D-3776 and is reported in g/m².

Tensile strength and Work to Break were determined by ASTM D-5035-95, with the following modifications. In the test a 2.54 cm by 20.32 cm (1 inch by 8 inch) sample was clamped at opposite ends of the sample. The clamps were attached 12.7 cm (5 in) from each other on the sample. The sample was pulled steadily at a speed of 5.08 cm/min (2 in/min) until the sample broke. The force at break was recorded in pounds/inch and converted to Newtons/cm as the breaking Tensile Strength. The Work to Break is a function of breaking tensile strength and elasticity and was recorded in Newton meters (Nm).

Puncture Resistance was determined by ASTM D-3420 and is reported in Newtons (N).

Trapezoidal Tear Strength was determined by ASTM D-5733 and is reported in Newtons (N).

Film thickness and composite thickness was determined by ASTM Method D1777-64 and is reported in micrometers.

Elongation to Break of a sheet is a measure of the amount a sheet stretches prior to failure (breaking)in a strip tensile test. A 1.0 inch (2.54 cm) wide sample is mounted in the clamps, set 5.0 inches (12.7 cm) apart, of a constant rate of extension tensile testing machine such as an Instron table model tester. A continuously increasing load is applied to the sample at a crosshead speed of 2.0 in/min (5.08 cm/min) until failure. The measurement is given in percentage of stretch prior to failure. The test generally follows ASTM D 5035-95.

Hydrostatic head was measured according to ISO 811, which measures the resistance to water penetration on a 7 in×7 in (18 cm×18 cm) test sample. Water pressure is applied at a rate of 60 cm/min to the film side of the test specimen until the sample is penetrated by water at three places. The hydrostatic pressure is measured in inches and converted to SI units and is reported in cm of water. The equipment used to measure hydrostatic head is made by Aspull Engineering Ltd, England.

Moisture Vapor Transmission Rate (MVTR) is reported in g/m²/24 hrs and was measured with a Lyssy Instrument using test method TAPPI T-523.

Slip angle is measured according to TAPPI Method T-503 and is reported in degrees. The higher the slip angle, the greater the resistance of the film to lateral sliding on a steel surface.

Smoothness of a film surface was measured to TAPPI Method T-555 in micrometers using a Parker Print Surf (PPS) test.

### EXAMPLE 1

The powder-bonded nonwoven used in this example was a 100% polyester powder-bonded nonwoven having a basis weight of 0.5 oz/yd² (17 g/m²) (obtained from HDK Company, Greenville, S.C.). The powder-bonded nonwoven layer was formed from DuPont Dacron® Type 54W polyester staple fibers 1.5 inches (3.81 cm) in length and having a denier per filament of 1.5. A copolyester powder adhesive is used at a loading of 18 percent by weight based on the total weight of the powder adhesive and staple fibers in the nonwoven web.

The powder-bonded composite nonwoven layer was extrusion coated with a polymer film layer of Hytrel® G4778 copolyether ester (melting point 208° C., vicat softening temperature of 175° C., a shore hardness of 47D, and a water absorption of 2.3%, sold by DuPont) using the process shown in FIG. 1. The Hytrel® polymer was fed in pellet form into a 3 inch (7.6 cm) diameter screw extruder and melted at a temperature of between 430° F. and 440° F. (221° C.-227° C.) and fed to a 30 mil (762μ) by 102 cm die opening in a heated die block maintained at 232° C. The powder-bonded nonwoven substrate was spaced about 12 inches (30.5 cm) below the opening of the die. The film thickness of 0.55 mil (14 microns) was laminated at 116 ft/min (35.4 m/min). The film was joined to the fibrous powder-bonded nonwoven substrate by passing the coated web through a pair of nip rolls with a nip roll pressure of 100 psi. The nip roll that faced the polymer melt was a silicone rubber roll having a matte finish. The quench bath temperature was maintained at 80° F. (27° C.).

The composite laminated sheet had the physical properties given in Table 1.

Comparative Example 1 is a single layer of Aptra® microporous film (available from Amoco) and Comparative Example 2 is a single layer of Tyvek® 1461 point bonded (linen×rib) flash-spun polyethylene sheet (available from DuPont). As can be seen from the data in Table 1, the Aptra® microporous film has very low tear strength which makes it very difficult to handle but it has very good slip resistance and smoothness. The Tyvek® 1461 flash-spun sheet has acceptable smoothness but does not have good slip resistance. The composite laminated sheet of Example 1 has a good combination of tear resistance, surface smoothness, and anti-slip properties.

TABLE 14

| | Example 1 | Comp. Ex. 1 | Comp. Ex. 2 |
|---|---|---|---|
| Basis Weight (g/m²) | 32.3 | 25.4 | 59.9 |
| Thickness (micrometers) | 57.2 | 29.9 | 185.6 |
| MVTR (g/m²/24 hrs) | 1136 | 1244 | 844 |
| Hydrostatic head (cm) | >400 | >90* | >90 |
| Tensile Strength (N/cm) | | | |
| MD¹ | 10.4 | 5.5 | 23.5 |
| CD² | 3.3 | 4.4 | 30.2 |
| Elongation (%) | | | |
| MD | 25.1 | 98.4 | 11.6 |
| CD | 68.3 | 44.1 | 17.2 |
| Work to Break (Nm) | | | |
| MD | 0.7 | 1.3 | 0.6 |
| CD | 0.4 | 0.5 | 1.1 |
| Puncture Resistance (N) | 32.2 | 24.5 | 177.5 |
| Trapezoidal Tear (N) | | | |
| MD | 3.9 | 0.5 | 59.3 |
| CD | 15.9 | 3.7 | 31.7 |
| Slip Angle (degrees) | 25.8-31.8 | 17.2-23.4 | 3.9-15.1 |
| | | | (linen side) |
| Smoothness (micrometers) | 5.0-6.7 | 0.9-1.0 | 4.0-5.8 |
| | | | (linen side) |

¹Machine Direction
²Cross Direction
*The microporous film of Comparative Example 1 physically burst during the test.

The composite laminated sheet of Example 1 was used as the primary material to contact the painted surface of automobile bumpers that had been painted with a “2K” paint system in preparation for shipping. A piece of the composite laminated sheet measuring approximately 132 inches long by 31 inches (335.2 cm by 78.7 cm) was draped over each bumper with the Hytrel® film layer facing the painted surface of the bumper fascia.

A bulky protective cover was made according to Example 4 in Jones et al. U.S. Pat. No. 5,763,336 and placed over the composite laminated sheet around each automobile bumper and the bumper was nested and stacked with other similarly covered bumpers and shipped from an equipment parts manufacturer to a vehicle manufacturing plant. Upon inspection of the bumpers after being transported, there was no evidence of damage or marking of the painted surfaces that is sometimes found when the bulky protective cover is used alone.

What is claimed is:

1. A method for packing an article comprising:
providing a vapor permeable and substantially water impermeable composite laminated sheet comprising a nonwoven layer and a polymer film layer, said composite laminated sheet having a trapezoidal tear strength of at least about 2 N in the machine direction, and a smoothness measured on the polymer film layer of less than 9 micrometers; and
placing the composite laminated sheet on the surface of the article with the polymer film layer contacting at least a portion of said surface.

2. The method according to claim 1, wherein said composite laminated sheet has a trapezoidal tear strength of at least about 3.9 N.

3. The method according to claim 1, wherein said composite laminated sheet has a slip angle of at least about 15 degrees, measured on the polymer film layer.

4. The method according to claim 1, wherein said polymer film layer comprises a vapor permeable polymer selected from the group consisting of polyethylenes, polypropylene, polyesters, polyurethanes, polyethers and polyvinyl alcohols and their copolymers.

5. The method according to claim 4, wherein said polymer film layer is an extruded monolithic film.

6. The method according to claim 4, wherein said polymer film layer is a microporous film.

7. The method according to claim 1, wherein said nonwoven layer is a powder-bonded nonwoven web.

8. The method according to claim 1, wherein said article has a soft, high-gloss finished surface.

9. The method according to claim 8, wherein said article is a painted automobile part.

10. The method according to claim 1, further comprising providing a cushioning material for said article.

11. The method according to claim 11, wherein said cushioning material is a nonwoven bulky composite laminated sheet.

12. The method according to claim 11, wherein said cushioning material comprises an open-celled polymer foam layer incorporated into said composite laminated sheet.

13. A protective cover for packing an article comprising a vapor permeable and substantially water impermeable composite laminated sheet comprising a nonwoven layer and a polymer film layer, said composite laminated sheet having a trapezoidal tear strength of at least about 2 N in the machine direction, and a smoothness measured on the polymer film layer of less than 9 micrometers.

14. The protective cover according to claim 13, wherein said composite laminated sheet has a trapezoidal tear strength of at least about 3.9 N.

15. The protective cover according to claim 13, wherein said composite laminated sheet has a slip angle of at least about 15 degrees, measured on the polymer film layer.

16. The protective cover according to claim 13, wherein said polymer film layer comprises a vapor permeable polymer selected from the group consisting of polyethylenes, polypropylene, polyesters, polyurethanes, polyethers and polyvinyl alcohols and their copolymers.

17. The protective cover according to claim 16, wherein said polymer film layer is an extruded monolithic film.

18. The protective cover according to claim 16, wherein said polymer film layer is a microporous film.

19. The protective cover according to claim 13, wherein said nonwoven layer is a powder-bonded nonwoven web.

20. The protective cover according to claim 13, further comprising a cushioning material for said article.

21. The protective cover according to claim 20, wherein said cushioning material is an open-celled polymer foam layer incorporated into said composite laminated sheet.

22. A vapor permeable, water impermeable composite laminated sheet comprising a first layer of polymer film bonded to a second layer of powder-bonded nonwoven web, wherein said polymer film is a monolithic extrudate.

23. The vapor permeable, water impermeable composite laminated sheet according to claim 22, wherein said composite laminated sheet has a trapezoidal tear strength of at least about 2 N in the machine direction, and a smoothness measured on the polymer film layer of less than 9 micrometers.

24. The vapor permeable, water impermeable composite laminated sheet according to claim 22, further comprising a cushioning layer.

25. The vapor permeable, water impermeable composite laminated sheet according to claim 24, wherein said cushioning layer comprises an open-cell polymer foam.

26. The vapor permeable, water impermeable composite laminated sheet according to claim 22, in which at least 95 weight percent of fibers in said nonwoven web are compatible with said polymer film.

27. A vapor permeable, water impermeable composite laminated sheet comprising a first layer of copolyether ester film and a second layer of powder-bonded polyester nonwoven web.

28. A vapor permeable, water impermeable composite laminated sheet consisting of a first layer of microporous polymer film bonded to a second layer of powder-bonded nonwoven web and optionally a cushioning layer.
